(19) United States
(12) Patent Application Publication
(10) Pub. No.: US 2018/0140980 A1
(43) Pub. Date: May 24, 2018

(54) EXCHANGE UNIT MOUNTING MANIFOLD

(71) Applicant: ROKI TECHNO CO., LTD., Tokyo (JP)

(72) Inventors: Tetsuya UCHIDA, Tokyo (JP); Hirofumi KAWAGOE, Tokyo (JP)

(21) Appl. No.: 15/574,819

(22) PCT Filed: May 18, 2015
(86) PCT No.: PCT/JP2015/002496

§ 371 Date: Nov. 16, 2017

(51) Int. Cl. B01D 35/30; B01D 27/08

(52) U.S. Cl. CPC B01D 35/306; B01D 2201/34; B01D 27/08

(57) ABSTRACT

The manifold includes a first pipeline end portion to which the first flow path end portion is joinable; a second pipeline end portion including a movable connecting portion being movable in a direction of approaching the first pipeline end portion and in a direction of separating from the first pipeline end portion, to which the second flow path end portion is connectable; and a stopper, which is provided between the first pipeline end portion and the second pipeline end portion, and is configured to position the exchange unit between the stopper and the first pipeline end portion. With this configuration, the exchange unit can easily be removed.

### TECHNICAL FIELD

The invention of the present application relates to a manifold configured to hold an exchange unit, which includes, for example, a filter or other members built therein, and is removably mounted so as to be replaceable as a part of an existing pipeline to enable formation of the pipeline.

### BACKGROUND ART

For a pipeline provided for the purpose of filtration of a fluid, an exchange unit, which includes a filter built therein, and is removable so as to be replaceable, is provided as a part of the pipeline. For example, after a predetermined amount of filtration is completed, an old exchange unit is removed to be replaced by a new exchange unit. The pipeline described above lacks a part thereof between an upstream-side end portion of the pipeline and a downstream-side end portion of the pipeline. The exchange unit has a structure which allows removable mounting thereof between the upstream-side end portion of the pipeline and the downstream-side end portion of the pipeline. The exchange unit has a flow path formed inside, and has a flow path inlet and a flow path outlet at both ends of the flow path. The filter or other members is arranged in the flow path. In general, the upstream-side end portion of the pipeline and the downstream-side end portion of the pipeline are constructed as a part of a manifold. When the exchange unit is mounted to the manifold, the flow path inlet of the exchange unit is joined to the upstream-side end portion of the pipeline, whereas the flow path outlet is joined to the downstream-side end portion of the pipeline. In this manner, the flow path of the exchange unit is coupled to the partially lacking pipeline to complete a pipeline of a flow circuit system.

### CITATION LIST

### Patent Literature

PTL 1: Japanese Patent Application Laid-Open No. H3-123689

### SUMMARY OF INVENTION

### Technical Problem

In Patent Literature 1, there is disclosed a water purifier cartridge to be used in a sink. In Patent literature 1, there are disclosed a manifold including a slidable sleeve pipe and the water purifier cartridge. On the manifold side, the distance between the upstream-side end portion of the pipeline and the downstream-side end portion of the pipeline remains unvaried. As the water purifier cartridge disclosed in Patent Literature 1, there is disclosed the water purifier cartridge in which one end of a flow path of the water purifier cartridge is screwed into one end of a pipeline of the manifold and the sleeve pipe of the manifold is extended to be coupled to another end of the pipeline of the manifold. However, the coupling using screwing is complicated for an engineer. At the same time, for a fluid having a high pressure, a form in which the slidable sleeve pipe is simply extended to be coupled to the another end of the pipeline of the manifold cannot be adopted. Further, an industrial filtering device using a filtered target which is liable to be solidified has a disadvantage in that, when a movable portion is provided to the manifold, the movable portion is firmly fixed, making it difficult to remove the exchange unit. Therefore, the manifold which enables easy removal of the exchange unit is desired.

### Solution to Problem

According to one embodiment of the present invention, in order to solve the problem, there is provided a manifold to which an exchange unit comprising a first flow path end portion, a second flow path end portion, and a flow path formed inside is removably mounted, the manifold being configured to form a flow circuit with the exchange unit mounted thereto, the manifold comprising: a first pipeline end portion to which the first flow path end portion is joinable; a second pipeline end portion comprising a movable connecting portion being movable in a direction of approaching the first pipeline end portion and in a direction of separating from the first pipeline end portion, to which the second flow path end portion is connectable; and a stopper, which is provided between the first pipeline end portion and the second pipeline end portion, and is configured to position the exchange unit between the stopper and the first pipeline end portion, in which the exchange unit is mountable to the manifold by connecting the first flow path end portion to the first pipeline end portion, moving the movable connecting portion in the direction of approaching the first pipeline end portion, and connecting the movable connecting portion to the second flow path end portion, and in which, when the movable is moved in the direction of separating from the first pipeline end portion, the stopper regulates movement of the exchange unit to release connection between the movable connecting portion and the second flow path end portion.

### Advantageous Effects of Invention

The manifold enables easy removal of the exchange unit.

### BRIEF DESCRIPTION OF DRAWINGS

FIG. 1 is a view for illustrating an exchange unit and a manifold being a part of a flow circuit to which the present invention is applied.

FIG. 2 is a view for illustrating a state in which the exchange unit is mounted to the manifold.

FIG. 3 is a view for illustrating a state during a process in which the exchange unit is being removed from the manifold.

FIG. 4 is a view for illustrating a state in which removal of the exchange unit from the manifold is enabled.

### DESCRIPTION OF EMBODIMENTS

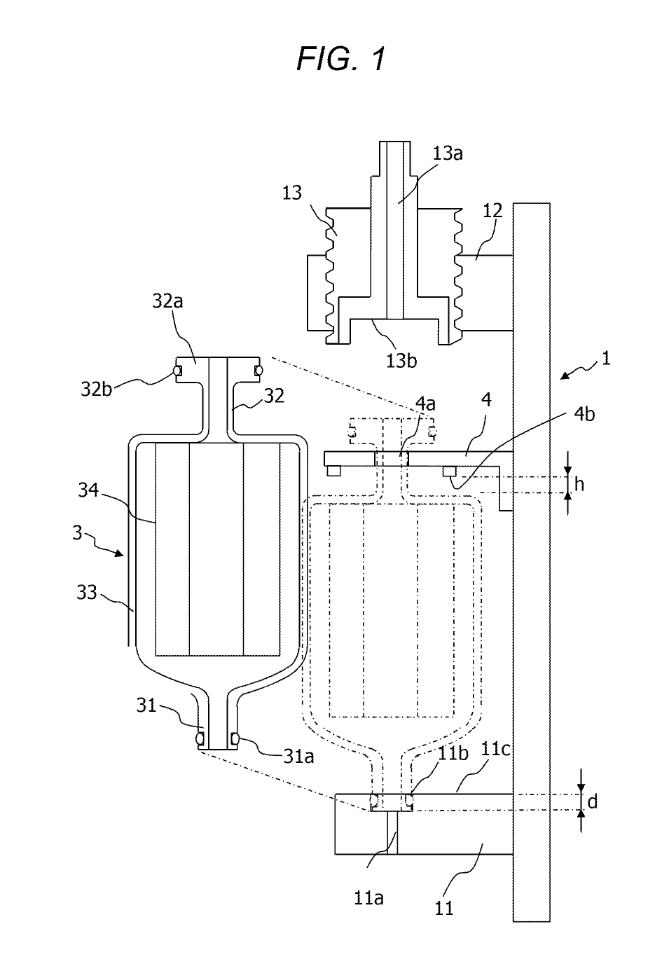

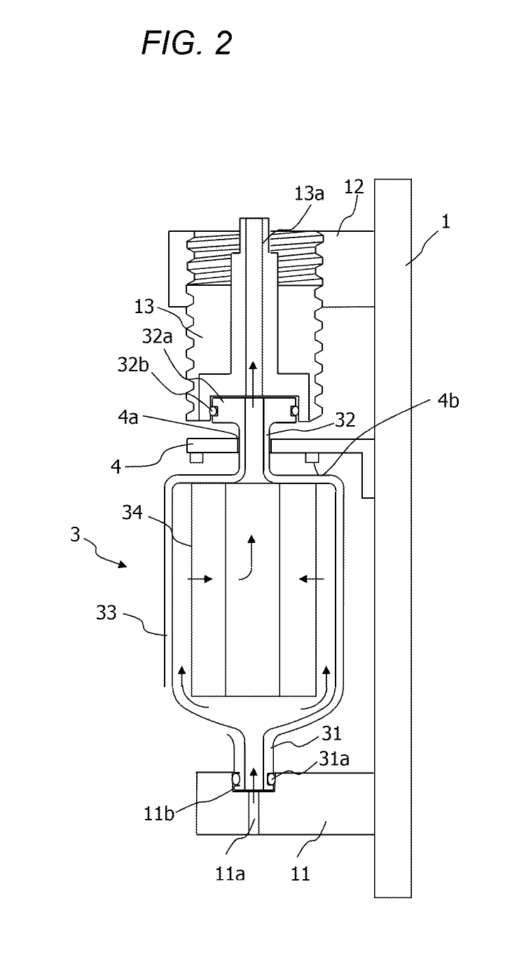

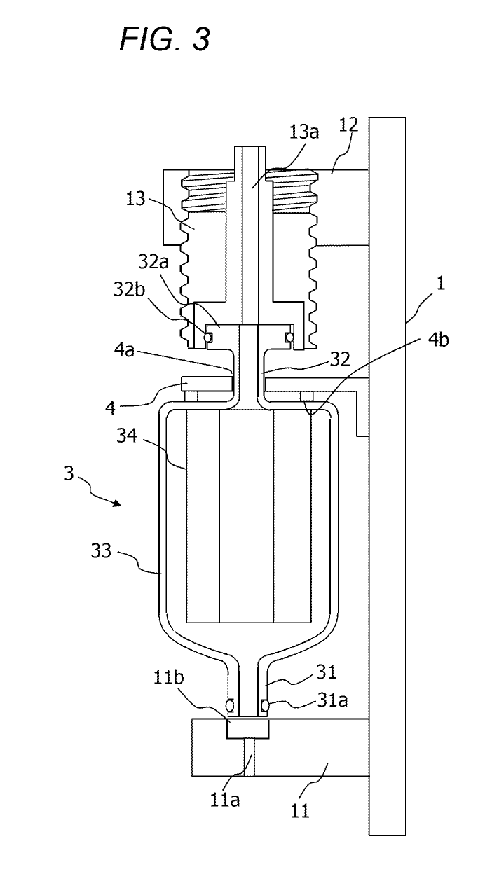

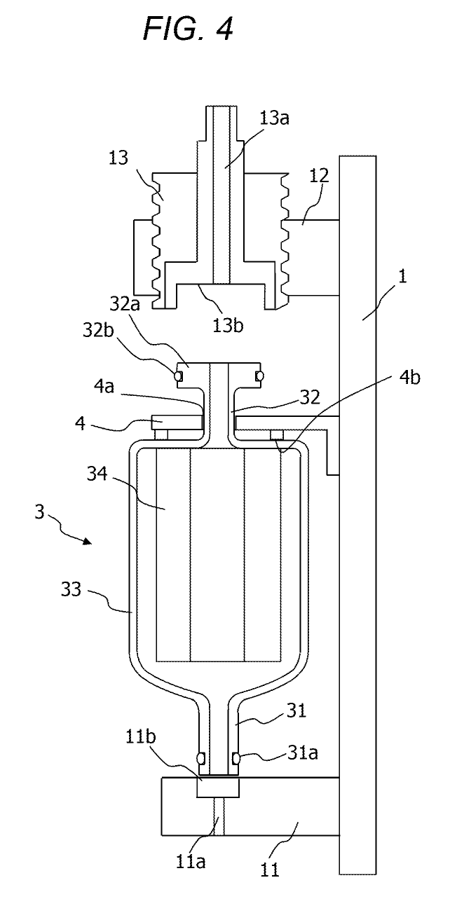

With reference to FIG. 1 to FIG. 4, the invention of the present application is described. FIG. 1 is a view for illustrating a manifold 1 according to the present invention, which is a part of a flow circuit, and an exchange unit 3 before being mounted. FIG. 2 is a view for illustrating the manifold 1 in a state in which the exchange unit 3 is mounted thereto. FIG. 3 is a view for illustrating the manifold 1 and the exchange unit 3 in a state during a process in which the exchange unit 3 is being removed. FIG. 4 is a view for illustrating the manifold 1 and the exchange unit 3 in a state in which removal of the exchange unit 3 is enabled. The manifold 1 includes a first pipeline end portion 11 and a second pipeline end portion 12. The first pipeline end portion 11 and the second pipeline end portion 12 are arranged so as to be opposed to each other, and each can be constructed as, for example, a block-like member.

The first pipeline end portion 11 has a recessed portion 11b which is formed by drilling so as to extend in a direction from the first pipeline end portion 11 to the second pipeline end portion 12. The recessed portion 11b representatively has a cylindrical shape. However, the shape of the recessed portion 11b is not necessarily limited to the cylindrical shape. The second pipeline end portion 12 has a movable joint portion 13. The movable joint portion 13 is movable in a direction toward the first pipeline end portion 11 with respect to the second pipeline end portion 12. For example, as illustrated in FIG. 1, the second pipeline end portion 12 has threads. The movable joint portion 13 is screwed into the second pipeline end portion 12. The movable joint portion 13 is movable while rotating so as to approach or separate from the first pipeline end portion 11. Further, a rail extending in the direction from the first pipeline end portion 11 to the second pipeline end portion 12 can be provided on the movable connecting portion 13 so that the movable connecting portion 13 is moved by a gear or the like in the direction in which the first pipeline end portion 11 approaches the second pipeline end portion 12 or the first pipeline end portion 11 separates away from the second pipeline end portion 12. In this case, the movable connecting portion 13 may have a manually moved structure, or may be moved by an electrical driving force of a motor or the like and a mechanical driving force of an air cylinder or the like.

For example, a pipeline 11a connected to a fluid source (not shown) is connected to the first pipeline end portion 11 to enable formation of an upstream side of the flow circuit, whereas a pipeline 13a connected to a destination of exhaust of the fluid (not shown) is connected to the movable connecting portion 13 of the second pipeline end portion 12 to enable formation of a downstream side of the flow circuit. However, a relationship between the upstream side and the downstream side of the manifold 1 is merely an example, and can be set oppositely. Hereinafter, the first pipeline end portion 11 side is described as the upstream side, and the second pipeline end portion 12 is described as the downstream side as an example in this specification.

The exchange unit 3 includes a first flow path end portion 31, a second flow path end portion 32, and a main body portion 33. The main body portion 33 has a hollow portion inside, and a filter 34 or other members may be arranged in the hollow portion. The filter 34 or other members is a filter member with an ion-exchange resin, an adsorbent such as zeolite or a diatom earth, a member obtained by combining the adsorbent and the filter member, or the like. Inside the exchange unit 3, a flow path from the first flow path end portion 31 through the filter 34 or other members to the second flow path end portion 32 is formed. The first flow path end portion 31 has, for example, a first width. The first flow path end portion 31 and the second flow path end portion 32 can representatively have a cylindrical shape. The main body portion 33 has a width larger than that of the second flow path end portion 32. Preferably, the main body portion 33 has a cylindrical shape with the width as a diameter. For mounting to the manifold 1, the first flow path end portion 31 is inserted into a recessed portion 11b formed on the first pipeline end portion 11 of the manifold 1. On an outer side of a distal end side of the first flow path end portion 31, a sealing member 31a such as an O-ring configured to seal between an outer surface of the first flow path end portion 31 and an inner surface of the recessed portion 11b is provided.

It is suitable that a flange 32a having a diameter larger than that of the second flow path end portion 32 be mounted to the second flow path end portion 32 of the exchange unit 3. A sealing member 32b such as an O-ring can be provided to the flange 32a. The second flow path end portion 32 of the exchange unit 3 is connected to the movable connecting portion 13 of the manifold 1. The movable connecting portion 13 has a connection receiving surface 13b. When the second flow path end portion 32 of the exchange unit 3 and the movable connecting portion 13 of the manifold 1 are connected to each other, the flange 32a abuts against the connection receiving surface 13b of the movable connecting portion 13 of the manifold 1. The sealing member 32b such as the O-ring is provided to the flange 32a, which enables sealing between the flange 32a and the connection receiving surface 13b of the movable connecting portion 13 of the manifold 1. The connection receiving surface 13b has, for example, a cylindrical shape which covers both a flange surface of the flange 32a and a side surface of the flange. When the sealing member 32b of the flange 32a is arranged on the side surface of the flange, the sealing member 32b arranged on the side surface of the flange 32a and a side surface of the connection receiving surface 13b having the cylindrical shape come into close contact with each other. By a frictional force generated thereby, the movable connecting portion 13 and the flange can be removably coupled against a force of gravity. The flange 32a is not always required. The second flow path end portion 32 may be, for example, a pipe having a constant thickness. Even in this case, it is only required that the sealing member 32b be provided on the side surface of the second flow path end portion 32 and that the connection receiving surface 13b have a cylindrical shape having a diameter approximately equal to the sealing member 32b. As long as an inner surface of the connection receiving surface 13b can press the sealing member 32b against the side surface of the second flow path end portion 32, the connection receiving surface 13b and the second flow path end portion 32 can be removably coupled by a frictional force generated between the inner surface of the connection receiving surface 13b and the side surface of the second flow path end portion 32. The sealing member 32b can also be provided on the connection receiving surface 13b side instead of being provided to the second flow path end portion 32 or the flange 32a. Further, it is preferred that, of the first flow path end portion 31 and the second flow path end portion 32, the first flow path end portion 31 be first moved out of the recessed portion 11b. Specifically, a frictional force generated between the first flow path end portion 31 and the recessed portion 11b and a frictional force generated between the second flow path end portion 32 and the movable connecting portion 13 be set so that the first flow path end portion 32 and the movable connecting portion 13 remain connected under a state after the flow path end portion 31 is moved out of the recessed portion 11b.

The manifold 1 includes a stopper 4. The stopper 4 is arranged so as to extend between the first pipeline end portion 11 and the second pipeline end portion 12 of the manifold 1. The stopper 4 defines a side on which the exchange unit 3 is mounted so that the main body portion 33 of the exchange unit 3 is arranged on a side opposite to the movable connecting portion 13 with respect to the stopper 4. The stopper 4 includes a passage portion 4a which passes through the first pipeline end portion 11 side of the manifold 1 and the second pipeline end portion 12 side of the manifold 1. The passage portion 4a may be, for example, a through hole, or may have a cutout shape having an opening on one side portion. The shape thereof only needs to allow the arrangement of the stopper 4 so that the second pipeline end portion 12 of the exchange unit 3 is positioned inside the passage portion 4a. Under the state in which the first flow path end portion 31 of the exchange unit 3 is inserted into the recessed portion 11b of the first pipeline end portion 11 of the manifold 1 to be installed therein, the second pipeline end portion 32 of the exchange unit 3 passes through the passage portion 4a of the stopper 4. As a result, a portion of the second flow path end portion 32 of the exchange unit 3 is positioned inside the passage portion 4a. Although the passage portion 4a is not required to retain the second flow path end portion 32, the passage portion 4a may be set to retain the second flow end portion 32. Under this state, the stopper 4 is positioned between the main body portion 33 of the exchange unit 3 and the flange 32a of the second flow path end portion 32.

Under the state in which the first flow path end portion 31 of the exchange unit 3 is inserted into the recessed portion 11b of the first pipeline end portion 11 of the manifold 1 to be installed therein, a certain distance h can be ensured between the stopper 4 and the main body portion 33. The stopper 4 may be fixed under a state in which the stopper 4 and the main body portion 33 are held in contact with each other (h=0). Here, the distance h is a distance from a state in which the first flow path end portion 31 of the exchange unit 3 is inserted at a preset position inside the recessed portion 11b to a state in which movement of the exchange unit 3 is regulated by the stopper 4. Further, a depth d of the recessed portion 11b is defined as a distance between a state in which the first flow path end portion 31 of the exchange unit 3 is inserted at a preset position inside the recessed portion 11b to a state in which the exchange unit 3 can be removed from the manifold 1 after a distal end portion of the first flow path end portion 31 of the exchange unit 3 is raised to a level of an opening portion of the recessed portion 11b. The distance h and the depth d of the recessed portion 11b are set so as to satisfy a relationship of h>d. With the setting to satisfy the above-mentioned relationship, the main body portion 33 of the exchange unit 3 has a width larger than that of the flow path end portion 32, and hence, when the exchange unit 3 comes into contact with shoulder portions 4b of the stopper 4, movement of the exchange unit 3 is regulated. Then, after the exchange unit 3 is moved to be brought into a state in which the movement thereof is regulated by the stopper 4, the distal end of the first flow path end portion 31 of the exchange unit 3 is always positioned out of the recessed portion 11b. Therefore, the exchange unit 3 can easily be removed.

Subsequently, with reference to FIGS. 1 and 2, description is made of a process in which the exchange unit 3 is mounted to the manifold 1. The engineer places the exchange unit 3 in the vicinity of the manifold 1 so that the first flow path end portion 31 of the exchange unit 3 is oriented toward the first pipeline end portion 11 of the manifold 1 and the second flow path end portion 32 of the exchange unit 3 is oriented toward the second pipeline end portion 12 of the manifold 1. Then, the first flow path end portion 31 of the exchange unit 3 is inserted into the recessed portion 11b of the first pipeline end portion 11 of the manifold 1 to be installed therein so that the second flow path end portion 32 of the exchange unit 3 is positioned inside the passage portion 4a of the stopper 4 (FIG. 1). Subsequently, the movable connecting portion 13 of the manifold 1 is moved in a direction of approaching the exchange unit 3 (downward direction in a case of this embodiment) to be brought into abutment against the flange 32a of the second flow path end portion 32 of the exchange unit 3 so that the flange 32a of the second flow path end portion 32 is pressed by the movable connecting portion 13 to be brought into close contact therewith. Under this state, the flow path inside the exchange unit 3 is joined to compensate for a lacking portion of the flow path being a part of the flow circuit, thereby completing the flow circuit.

Next, with reference to FIG. 3 and FIG. 4, a process of removing the exchange unit 3 from the manifold 1 is described. The movable connecting portion 13 of the manifold 1 is moved in a direction of separating from the first pipeline end portion 11 of the manifold 1 (upward direction in the case of this embodiment). The flange 32a and the connection receiving portion 13b are coupled to each other. Therefore, the exchange unit 3 is moved together with the movable connecting portion 13 in the direction of separating from the first pipeline end portion 11 to remove the first flow path end portion 31 of the exchange unit 3 from the recessed portion 11b. With further movement of the movable connecting portion 13, the main body portion 33 of the exchange unit 3 abuts against the stopper 4 to regulate the movement of the exchange unit 3 in the direction of separating from the first pipeline end portion 11. With further movement of the movable connecting portion 13 from this state, connection between the exchange unit 3 and the movable connecting portion 13 is released, thereby enabling removal of the exchange unit 3.

In this embodiment, description is made of the example in which the first pipeline end portion 11 of the manifold 1 has the recessed portion 11b. However, the first pipeline end portion 11 of the manifold 1 may be a projection, and the first pipeline end portion 31 of the exchange unit 3 may have a recessed shape. Any arrangement may be used as long as the first pipeline end portion 11 of the manifold 1 and the first flow path end portion 31 of the exchange unit 3 can be connected to each other. In this case, a height of the projection corresponds to the depth d of the recessed portion 11b. When the above-mentioned relationship of h>d is satisfied, the same effect is provided.

In this embodiment, description is made of the mode in which the removal of the exchange unit 3 from the manifold 1 is enabled in a single efficient working process in terms of the relationship of h>d. However, a relationship of h<d (including h=0) may be set as long as the stopper 4 is configured to be movable so as to retreat from the manifold 1 although the number of working processes increases. In this case, after the movable connecting portion 13 of the manifold 1 is moved in the direction of separating from the first pipeline end portion 11 of the manifold 1 (upward direction in the case of this embodiment), connection between the movable connecting portion 13 and the second flow path end portion 32 of the exchange unit 3 can be set to be first released. Then, after the stopper 4 is retreated, connection between the first flow path end portion 31 of the exchange unit 3 and the first pipeline end portion 11 of the manifold 1 is released.

### REFERENCE SIGNS LIST

1 manifold

3 exchange unit

4 stopper

11 first pipeline end portion

12 second pipeline end portion

31 first flow path end portion

32 second flow path end portion

33 main body portion

34 filter

1. A manifold to which an exchange unit comprising a first flow path end portion, a second flow path end portion, and a flow path formed inside is removably mounted, the manifold being configured to form a flow circuit with the exchange unit mounted thereto, the manifold comprising:
a first pipeline end portion to which the first flow path end portion is joinable;
a second pipeline end portion comprising a movable connecting portion being movable in a direction of approaching the first pipeline end portion and in a direction of separating from the first pipeline end portion, to which the second flow path end portion is connectable; and
a stopper, which is provided between the first pipeline end portion and the second pipeline end portion, and is configured to position the exchange unit between the stopper and the first pipeline end portion,
wherein the exchange unit is mountable to the manifold by connecting the first flow path end portion to the first pipeline end portion, moving the movable connecting portion in the direction of approaching the first pipeline end portion, and connecting the movable connecting portion to the second flow path end portion, and
wherein, when the movable portion is moved in the direction of separating from the first pipeline end portion, the stopper regulates movement of the exchange unit to release connection between the movable connecting portion and the second flow path end portion.

2. The manifold according to claim 1, wherein, under a state in which the movement of the exchange unit is regulated by the stopper, connection between the first flow path end portion and the first pipeline end portion is released.

3. The manifold according to claim 1, wherein a sealing member is provided to any one of the movable connecting portion and the second flow path end portion, and the sealing member is brought into close contact with an inner surface of another of the movable connecting portion and the second flow path end portion to connect the movable connecting portion and the second flow path end portion to each other.

4. The manifold according to claim 2, wherein a sealing member is provided to any one of the movable connecting portion and the second flow path end portion, and the sealing member is brought into close contact with an inner surface of another of the movable connecting portion and the second flow path end portion to connect the movable connecting portion and the second flow path end portion to each other.
